(19) United States
(12) Patent Application Publication
(10) Pub. No.: US 2025/0332064 A1
(43) Pub. Date: Oct. 30, 2025

(54) SYSTEMS AND METHODS FOR TRIGGERED ACTIONS IN POOL OR SPA SYSTEM ELECTRICAL ENCLOSURE BASED ON DOOR POSITION

(71) Applicant: ZODIAC POOL SYSTEMS LLC, Carlsbad, CA (US)

(72) Inventors: Darin Eames, Carlsbad, CA (US); Minas Minassian, Carlsbad, CA (US); Jared Leander, Carlsbad, CA (US)

(73) Assignee: ZODIAC POOL SYSTEMS LLC, Carlsbad, CA (US)

(21) Appl. No.: 19/093,467

(22) Filed: Mar. 28, 2025

Related U.S. Application Data
(60) Provisional application No. 63/640,429, filed on Apr. 30, 2024.

(51) Int. Cl. A61H 33/00; E04H 4/14; F21V 23/04; G07C 9/32; G08B 13/22; H02G 3/08

(52) U.S. Cl. CPC A61H 33/005; E04H 4/14; G07C 9/32; G08B 13/22; H02G 3/08; A61H 2033/0083; A61H 2201/5007; A61H 2201/5064; A61H 2201/5092; F21V 23/0471

(57) ABSTRACT

A pool or spa system may include one or more electrical enclosures for housing electrical components of a pool or spa system. An electrical enclosure may include a door, a switch configured to detect a position of the door, and one or more electrical components for powering one or more pieces of pool or spa equipment in which the first electrical component performs an action in response to a change in the position of the door. The electrical enclosure may further include a pool automation controller configured to output commands to cause a first action by the first electrical component responsive to receiving a signal from the switch corresponding to the door opening and a second action by the first electrical component responsive to receiving a signal from the switch corresponding to the door closing.

### CROSS-REFERENCE TO RELATED APPLICATION

This application claims priority to provisional application U.S. Ser. No. 63/640,429 entitled “SYSTEMS AND METHODS FOR TRIGGERED ACTIONS IN POOL OR SPA SYSTEM ELECTRICAL ENCLOSURE BASED ON DOOR POSITION” and filed on Apr. 30, 2024, the entire disclosure of which is incorporated herein by reference for any purpose.

### FIELD

This disclosure relates to the securing and tracking of electrical enclosure access and more particularly, although not exclusively, to systems and techniques for triggering actions performed in response to door position of an electrical enclosure within a pool or spa system.

### BACKGROUND

A conventional pool and spa system may include one or more electrical enclosures providing power and/or control to various items of pool or spa equipment and devices. These electrical enclosures oftentimes include various electrical components to allow operation of the pool or spa equipment and devices. Because electrical enclosures are typically close to bodies of water, preventing stray water from entering inadvertently open electrical enclosures and causing electrical shorts, fires, or other damage is of paramount concern. Likewise, electrical components inside open electrical enclosures, such as sensitive user interface displays, may be vulnerable to sun damage.

Additionally, because pools and spas are generally highly trafficked areas, securing and tracking access to the electrical enclosures may be critical to ensuring proper operation of various items of pool or spa equipment and devices. Securing access to the electrical enclosure may also be critical to protecting curious patrons from damaging the enclosure, the items of pool or spa equipment and devices, and even protecting the patrons themselves.

### SUMMARY

One example electrical enclosure for a pool or spa system includes: a door; a switch configured to detect a position of the door; and one or more electrical components associated with operation of the pool or spa system including a first electrical component, in which the first electrical component performs an action in response to a change in the position of the door.

An example pool or spa system includes: a housing that defines an interior volume; a door mounted to the housing and configured to selectively enclose the interior volume; a first electrical component disposed within the housing, the first electrical component associated with operation of the pool or spa system and configured to perform one or more actions based on a position of the door; a switch disposed within the housing configured to detect the position of the door; and one or more pieces of pool or spa equipment.

An example method for operating electrical components of a pool or spa system by a pool automation controller includes: outputting a first command to cause a first action by an electrical component of an electrical enclosure responsive to receiving a first signal from a switch configured to detect a position of a door of the electrical enclosure, the first signal corresponding to the door opening; and outputting a second command to cause a second action by the electrical component responsive to receiving a second signal from the switch, the second signal corresponding to the door closing.

### BRIEF DESCRIPTION OF THE DRAWINGS

FIGS. 1A-1C illustrate examples of electrical enclosures, according to some aspects of the present disclosure.

FIG. 2 illustrates a flow chart representing process demonstrating the response of a pool automation controller at an electrical enclosure to signals generated from a door switch, according to some aspects of the present disclosure.

FIG. 3 illustrates a flow chart representing process demonstrating actions taken by a pool automation controller at an electrical enclosure, according to some aspects of the present disclosure.

FIG. 4 illustrates an example log of user interactions with the electrical enclosure and automation controller, according to some aspects of the present disclosure.

FIG. 5 illustrates a flow chart representing an example process for logging user access events a pool automation controller at an electrical enclosure, according to some aspects of the present disclosure.

FIG. 6 illustrates a flow chart representing process showing adjustments to electrical components responsive to changing the position of the door of a housing or electrical enclosure, according to some aspects of the present disclosure.

FIG. 7 illustrates examples of components of a computer system, according to some aspects of the present disclosure.

### DETAILED DESCRIPTION

A pool and spa system, in addition to one or more bodies of water, may also include a constellation of equipment and devices such as circulation or other kinds of pumps, filtration systems, heaters, chlorinators, skimmers, drain systems, level sensors, and so on. Such equipment can be configured and operated using a centralized pool automation controller. Pool and spa systems of even modest complexity may require robust electrical infrastructure to power and control the various included equipment. The required electrical infrastructure and control circuitry may be housed within one or more electrical enclosures (sometimes referred to as a “housing”) distributed throughout the pool or spa system, which can serve as hubs for distributing power and managing operations across the entire pool or spa system. The electrical enclosures can contain electrical components such as the pool automation controller, user interfaces, relays, circuit breakers, transformers, cooling devices, or other electrical components.

Pools and spa systems may be high-traffic environments frequented by individuals. Consequently, securing access to the electrical enclosures is a critical design consideration. For example, improper handling or tampering with the electrical components inside the enclosure could disrupt the operation of essential pool or spa systems, potentially leading to costly repairs or even rendering the pool or spa system unusable. Existing approaches to securing electrical enclosures are inadequate for securing against unrestricted or unauthorized access.

Closely related to these safety and security concerns, existing designs for electrical enclosures lack facilities for tracking access to the electrical enclosures. Existing designs for electrical enclosures often lack integrated systems for tracking access, relying instead on manual record-keeping or ad hoc monitoring by operators. Such approaches fail to provide detailed, real-time data on who accessed the enclosure, when, and for what purpose, limiting the ability to ensure accountability and predict maintenance needs. For instance, automatically maintained electrical enclosure access logs could be used to identify whether routine maintenance schedules are being adhered to or if unauthorized individuals are attempting to gain entry. Such tracking mechanisms not only enhance security but also facilitate predictive maintenance, allowing operators to address potential problems proactively before they escalate into major failures.

To address these challenges, systems, devices, and techniques for triggering actions at an electrical enclosure of a pool or spa system based on door position of the electrical enclosure are disclosed. The techniques disclosed herein can be used to manage and secure access to electrical enclosures in pool and spa systems. These innovations can utilize sensors, switches, and/or pool automation controllers to monitor the position of enclosure doors and trigger specific actions based on their status. For example, opening a door might activate a display, log the user's identity, or even trigger an alarm if the access is unauthorized.

In one example method for triggering actions in response changes in position of an electrical enclosure door, a first action is triggered at an electrical enclosure responsive to receiving a first signal from a door switch configured to detect one or more states of a door of the electrical enclosure. For example, opening the door of the electrical enclosure may trigger a pool automation controller to activate a display, turn on a light, capture an image of the individual accessing the enclosure for authentication, or record the opening in a suitable audit log. Then, a second action is triggered at the electrical enclosure in response to receiving a second signal from the door switch. For example, closing the door may prompt the system to power down electrical components, reset to a secure state, or log the door closing event.

The actions may be effectuated by a pool automation controller housed at the electrical enclosure. The pool or spa system may include the electrical enclosure, as well as several items of pool or spa equipment and devices (e.g., pumps, heaters, chlorinators, lights, speakers, etc.). The electrical enclosure may include various electrical components and circuitry, such as relays, breakers, fuses, transformers, a plunger switch, lights such as LEDs, among other things. The electrical enclosure may also include the pool automation controller. The pool automation controller may control the pool or spa equipment and devices and may include a micro-controller and an interface (e.g., a screen and input device, touchscreen, etc.). These electrical components and pool automation controller may be secured within the electrical enclosure and accessible to a user by opening a door of the electrical enclosure.

The door of the electrical enclosure may be configured with a switch such that when a user opens the door of the electrical enclosure, the switch changes its state from an opened to a closed state, or vice versa. In some examples, the switch is a plunger switch located on a hinge of the door or positioned on the side of the door facing the interior of the electrical enclosure. In further examples, the plunger switch is located on an interior face of the electrical enclosure.

A change in state of the switch may trigger an action performable by the pool automation controller, such as triggering the pool automation controller to turn on a display. For example, a user may open the door of the electrical enclosure thereby changing the state of the switch. The pool automation controller may receive a signal associated with the change in state of the switch and turn on the display or take another action in response to the signal. In further examples, the pool automation controller may power on or off other devices within the electrical enclosure or items of pool or spa equipment in response to the signal.

In further examples, the electrical enclosure may be configured with a magnetic switch, such as a reed switch, to determine the position of the door. For example, the electrical enclosure may include a reed switch as a proximity sensor which the pool automation controller may use to determine the position of the door. In some examples, the electrical enclosure may be configured with other sensors enabling sensing multiple positions of the door, such as an inductive position sensor, a time of flight (TOF) sensor, and/or an infrared sensor.

In another example, the pool automation controller may turn on a light in response to the signal. For example, the pool automation controller may turn on a light when the signal indicates the door to the electrical enclosure is open and turn off the light when the signal indicates the door is closed or locked. By powering on and off the light based on the state of the switch, the pool automation controller may indicate to users when the door to the electrical enclosure is closed or left ajar.

In an additional example, the pool automation controller may perform one or more routines in response to the signal. In one example, the pool automation controller may populate a user interface with user information, state information of devices within the electrical enclosure or connected items of pool or spa equipment, and/or other suitable information relating to the pool and spa system. For example, the pool automation controller may perform diagnostic tests on devices within the electrical enclosure and connected items of pool or spa equipment and populate a user interface with results from the diagnostic tests.

In another example, the pool automation controller may transition from a low-power state to a high-power state, and vice versa, in response to the signal. For example, the pool automation controller may transition to a high-power state in preparation for receiving inputs from a user opening the door to the electrical enclosure. When the door is closed, the pool automation controller can remain in a dormant, low-power mode to conserve electrical power and reduce heat inside the electrical enclosure.

In a further example, the pool automation controller may activate a camera to take a photo to identify an individual who opened the electrical enclosure. In some examples, the pool automation controller may be connected to the Internet, such as by connecting to a WiFi router or cellular services. In further examples, the pool automation controller may authenticate the identity of the individual by comparing the photo of the individual to a database of authorized users. In further such examples, authentication may be performed by an application executed on a device or server outside of the electrical enclosure, which may return a confirmation that the individual is an authorized user.

The pool automation controller may generate a log to track the identity of individuals who open the electrical enclosure and to track actions performed by the individuals opening the electrical enclosure. For example, an individual may open the electrical enclosure to replace a broken electrical component. The pool automation controller may identify that the individual replaced an electrical component based on changes in performance of electrical components within the electrical enclosure after the individual opens the electrical enclosure. In some examples, when the individual is an authorized user, the authorized user may provide input to a log through the interface of the pool automation controller to provide an explanation for why the authorized user opened the electrical enclosure (e.g., to perform maintenance, for cleaning, on accident, etc.).

In some examples, the pool automation controller may predict the next time the electrical enclosure is opened and the reason for its opening based on the log. For example, an authorized user may open the electrical enclosure on a particular schedule for maintenance, which the pool automation controller may log. When the pool automation controller determines that the authorized user has not performed his or her regular maintenance, the pool automation controller may send a reminder indicating the maintenance has not been performed or otherwise generate an alert.

In some examples, opening the electrical enclosure may trigger an alarm, for example if it is determined that an individual opening the enclosure is not an authorized user. In some examples, the alarm could be an outside alarm that alerts authorities.

The systems and methods according to this disclosure constitute a significant improvement to the technical field of securing and tracking of electrical enclosure access. In addition to addressing the challenges described above, the systems and methods according to this disclosure not only enhance safety and security but also provide operators with detailed data to optimize maintenance schedules and ensure compliance with operational standards. By integrating such intelligent control mechanisms, pool and spa operators can create a safer, more efficient, and highly accountable environment for their facilities. Additionally, the automation of functions relating to electrical enclosure door state changes can lead to improved data-driven insights that can be used to further safeguard critical electrical components, streamline operations, and optimize maintenance in high-traffic environments.

These illustrative examples are given to introduce the reader to the general subject matter discussed herein and the disclosure is not limited to these examples. The following sections describe various additional non-limiting examples of systems and methods for triggering actions performed in response to door position of an electrical enclosure within a pool or spa system.

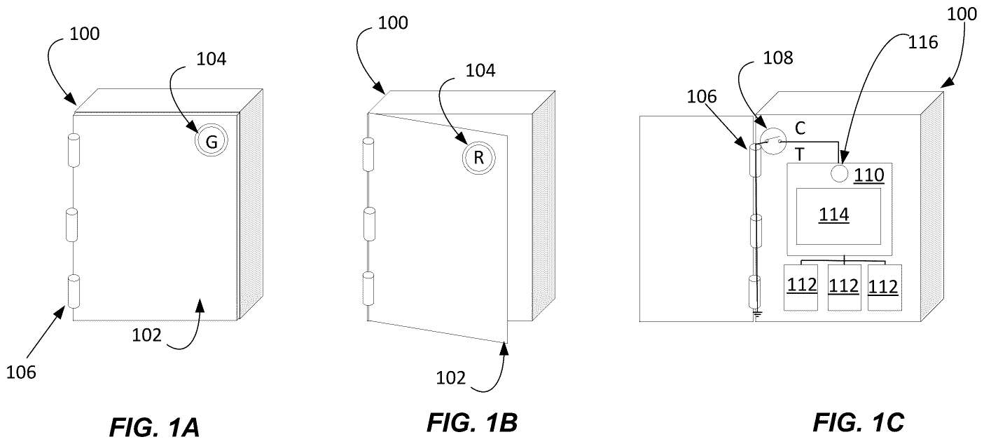

Turning now to the figures, FIGS. 1A-1C illustrate examples of electrical enclosures, according to some aspects of the present disclosure. Electrical enclosures may also be referred to as “housings.” FIG. 1A depicts an electrical enclosure 100 with door 102 in a closed position. The electrical enclosure 100 includes one or more hinges 106, an indication light 104. By way of example, the light 104 is shown on the door 102, but the light 104 could be positioned on a side, top, or bottom of the electrical enclosure 100 or externally thereto. FIG. 1B depicts the electrical enclosure 100 with door 102 slightly ajar. FIG. 1C depicts the electrical enclosure 100 with door 102 in a fully open position. With door 102 fully open, the internals of the electrical enclosure 100 are visible, including a switch 108 and various electrical components including a pool automation controller 110, an interface 114, a camera 116, and various additional electrical components 112. The indication light 104 is another example of an electrical component that may be associated with the electrical enclosure 100. In general, the electrical components can be associated with operation of the pool or spa system. For example, the electrical components can add various functionality to the electrical enclosure 100, control the operation of pool or spa equipment, and so on.

The pool automation controller 110 may be a computing device housed within the electrical enclosure 100. The pool automation controller 110 can be configured to manage or automate the operation of pool or spa equipment, such as pumps, lights, chlorinators, heaters, and other equipment. The pool automation controller 110, for example, can respond to signals from sensors, performs actions like triggering alarms or activating displays, or facilitates user interactions through integrated user interfaces, such as interface 114.

The interface 114 may be, for example, an embedded control panel including a touchscreen or other input device, which enables pool or spa maintainers or operators to install, configure, maintain, or operate the pool automation controller 110. For example, the interface 114 may include functionality such as authorization and authentication, viewing or updating pool or spa system status, and configuring the pool or spa system. Camera 116 may also be integrated into the electrical enclosure 100. The camera 116 can be used, for example, for security and monitoring that can capture images or videos of individuals accessing the system for biometric analysis. For instance, captured images can support user authentication or logging.

The electrical enclosure 100 also includes various additional electrical components 112. The electrical components 112 may include electrical hardware such as breakers, fuses, relays, and transformers configured to provide power distribution and protection for the pool or spa system. The electrical components 112 may also include peripheral devices such as speakers for alarms or communication modules for internet or cellular connectivity (e.g., WiFi routers or access points, Bluetooth modems, etc.).

The switch 108 may be a plunger switch or any other suitable switch or sensor appropriate for the configuration, such as a reed switch, inductive position sensor, or a time-of-flight sensor. For example, the position of the door 102 can be detected using a magnetic reed switch, in which a magnet mounted on the door aligns with a reed switch on the electrical enclosure door frame and changes state when the door 102 changes position. Some examples may include limit switches based on mechanical arms or rollers that depress when the door 102 is closed and release when it is opened. Some examples may use optical sensors that use infrared beams or lasers to detect when the door 102 is obstructing the beam path. In some examples, capacitive or inductive proximity sensors can be used. Such sensors can change state in response to changes in certain electrical properties of the included materials as the door 102 position changes. For instance, capacitive proximity sensors may be responsive to changes in the dielectric properties of a circuit embedded in the electrical enclosure 100. Some examples may include a time-of-flight sensor that can measure the time it takes for emitted light (e.g., from an emitter situated within the electrical enclosure 100) to reflect off the door 102 and return to the sensor.

The switch 108 may be attached to a hinge 106 of door 102. In other examples, the switch may be attached to a side of the door 102 facing the interior of the electrical enclosure 100 or a side of the electrical enclosure 100 facing the door 102. In further examples, the switch may be located on an exterior surface of the electrical enclosure 100.

When the door 102 is shut, as in FIG. 1A, the switch 108 may be in a first state (e.g., closed). The pool automation controller 110 can determine, based on the state of the switch 108, that the door 102 is closed. Accordingly, the light 104 can be caused to output green (or other suitable visual indication) to indicate the door 102 is shut. When the door 102 is open, the switch 108 (or other position detection mechanism) can transition to a second state (e.g., open). The pool automation controller 110 can determine, based on the state of the switch 108, that the door 102 is open. The light 104 can be caused to show a red color (or other suitable visual indication) that the door is now open, as shown in FIG. 1B and implied in FIG. 1C. In addition to colors, the light 104 can be configured to communicate information about the door 102 position in other manners. For instance, in some examples, the light 104 can be off or unpowered when the door 102 is closed and on or powered (e.g., red or incandescent white color) when the door 102 is open.

In some examples, the state of the door 102 can directly control the switch 108, such that closing the switch 108 connects the light 104 to a power source, enabling automatic activation of the light 104 without a signal from the pool automation controller 110. In some examples, the operation of the light 104 as described in this paragraph can be based on additional state information about the door 102. For example, the light 104 may be illuminated (e.g., using green) only when the door 102 properly seated and/or latched. Detection of such state information can be collected using additional switches or sensors, such as contact sensors that can close the lighting circuit when the door 102 is fully latched by detecting physical contact between two conductive points. In another example, latch position sensors, such as microswitches or Hall effect sensors, can be used to close the lighting circuit when a door latching mechanism is engaged.

The pool automation controller 110 may perform various actions in response to a change in state of the switch 108. For example, a change in state of the switch 108 indicating the door 102 is open may trigger the pool automation controller 110 to take a photo using camera 116, display a message on interface 114, trigger an alarm, and/or perform any other suitable action. In some examples, a change in state of the switch 108 indicating the electrical enclosure is open may cause the pool automation controller to display a prompt on interface 114 requesting user credentials to access the electrical enclosure 100. For example, a user may provide the user credentials to the pool automation controller as inputs at a user interface, such as interface 114, of the pool automation controller 110 including a username and password. Once the credentials have been verified, the pool automation controller 110 may perform certain actions such as turning off the alarm. In some examples, biometric authentication using camera 116 or other biometric authentication device can be actuated upon detection of a state change in the switch 108.

The pool automation controller 110 can coordinate responses from the various additional electrical components 112 based on changes in the position of the door 102. For instance, when the door 102 transitions from a closed to an open state, the controller may activate breakers or relays to temporarily isolate power to sensitive electrical components for safety. Similarly, connected peripherals, such as speakers, may emit an alarm sound to alert personnel of unauthorized access, while communication modules like Bluetooth modems or WiFi routers may send notifications or alerts to designated users. Conversely, when the door 102 is closed, the pool automation controller may restore standard operational configurations, such as reconnecting power circuits, disabling alarms, or switching off non-critical peripherals, ensuring the system returns to its secure and functional baseline.

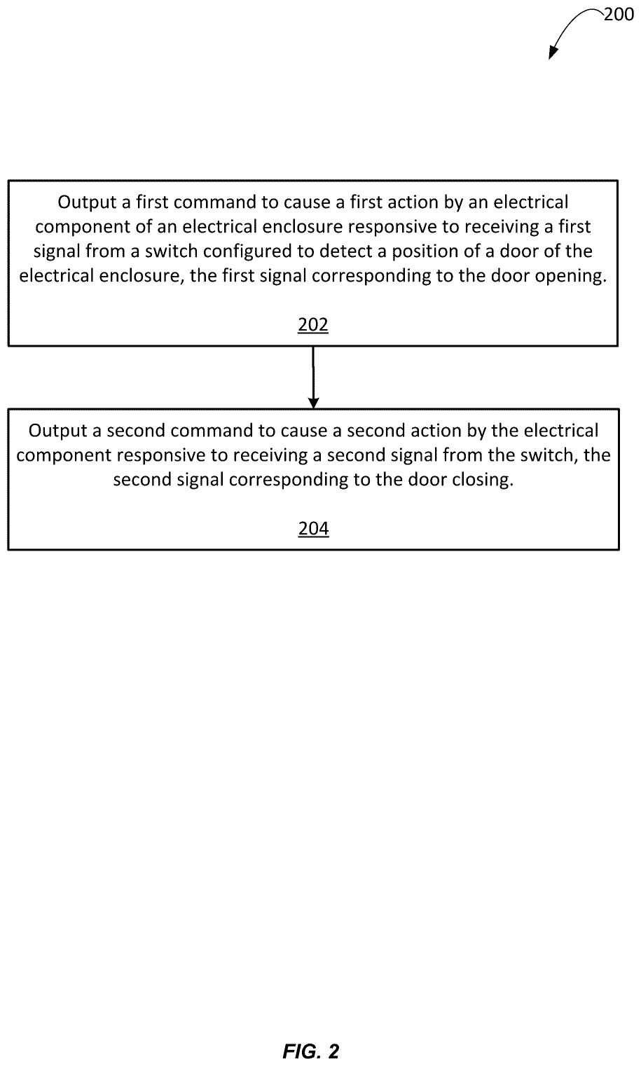

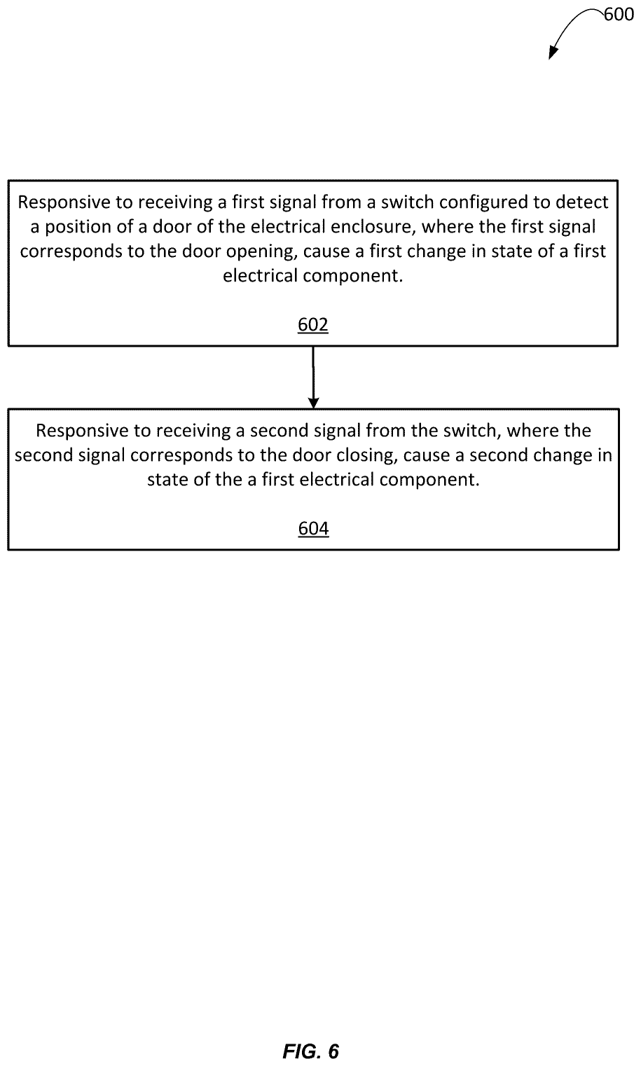

FIG. 2 illustrates a flow chart representing process 200 demonstrating the response of a pool automation controller at an electrical enclosure to signals generated from a door switch, according to some aspects of the present disclosure. Process 200 may represent various steps performable by the system described in the description of FIG. 1 and FIG. 6. For example, process 200 may demonstrate steps taken by a pool automation controller at an electrical enclosure in response to received signals associated with the state of a switch.

This process, and any other processes described herein (e.g., 300 and 500), is illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

Process 200 may begin at block 202 which includes outputting a first command to cause a first action by the first electrical component responsive to receiving a first signal from the switch, the first signal corresponding to the door opening. For example, the door switch may be configured to generate signals associated with one or more states of a door of an electrical enclosure, such as the electrical enclosure described further in the description of FIG. 1. In some examples, the door switch may be any other suitable switch or sensor appropriate for the configuration, such as a reed switch, inductive position sensor, or a time-of-flight sensor. A pool automation controller, such as the pool automation controller 110 further described in the description of FIG. 1, may receive the first signal from the door switch.

In some examples, the door switch may generate signals for more than two states of the door, such as different signals indicating one of an open, closed, partially open, or not fully closed states. In some examples, the switch alone or the switch in connection with one or more other sensors may be useable to determine a degree to which the door is open (e.g., 1 degree, 5 degrees, 20 degrees, etc.). Different actions may be triggered based on the “how” open the door is.

The first action at the first electrical enclosure is responsive to receiving the first signal. For example, the first electrical enclosure may include a pool automation controller, such as the pool automation controller 110 further described in the description of FIG. 1. The pool automation controller may include instructions stored in memory of the controller indicating an action to perform in response to the first signal. For example, the pool automation controller may turn on a red light when the first signal indicates the door is open. In other examples, the pool automation controller may cause a peripheral of the pool automation controller to perform an action, such as causing a camera to take a photo of a user opening the electrical enclosure. In some examples, the pool automation controller may cause multiple peripherals to perform a sequence of actions or to perform actions concurrently. For example, the pool automation controller may cause an alarm to go off, which might include turning on a light, playing an alarm sound through a speaker, and/or sending an alert to authorities or the homeowner warning the electrical enclosure is open.

In further examples, the action performed by the pool automation controller might be to turn on a display and user interface to allow users to provide inputs to the pool automation controller. The user interface can be used to configure or operate electrical components of the first electrical enclosure as well as various pieces of pool or spa equipment. For example, users may adjust settings for pool pumps, lights, or heaters, or input maintenance schedules and diagnostic commands directly through the user interface.

Although this method 200 involves the pool automation controller outputting the first command, in some examples, the operation of the door and actuation of the switch may cause the first action without the intervening pool automation controller. For example, the switch may close or open a circuit that is a direct electrical connection between the switch and the electrical component, thus causing the first action. For instance, closing the door may cause open a circuit to cause a light to extinguish, while opening the door may close a circuit to cause the light to illuminate. Additional examples of this scenario are described below in FIG. 6.

At block 204, process 200 may include outputting a second command to cause a second action by the first electrical component responsive to receiving a second signal from the switch, the first signal corresponding to the door closing. For example, when the second signal indicates the door is closed, the pool automation controller may perform the second action, such as disarming an alarm. In other examples, the second action may be to power down a display inside of the electrical enclosure and/or return the electrical enclosure to a pre-door-opened state (e.g., change the light from red to green).

In some examples, the first action may involve applying electrical power using the first electrical component to a first piece of pool or spa equipment of the one or more pieces of pool or spa equipment. Then, the second action may be removing the electrical power using the first electrical component from the first piece of pool or spa equipment. For instance, the pool automation controller may apply electrical power to a heater when the door is opened, allowing maintenance personnel to test its functionality, and subsequently remove power from the heater when the door is closed to conserve energy. Similarly, the pool automation controller can activate pool lights upon detecting the door is open to illuminate the area for inspection or maintenance and turn them off automatically once the door is closed to restore the system's default operational state.

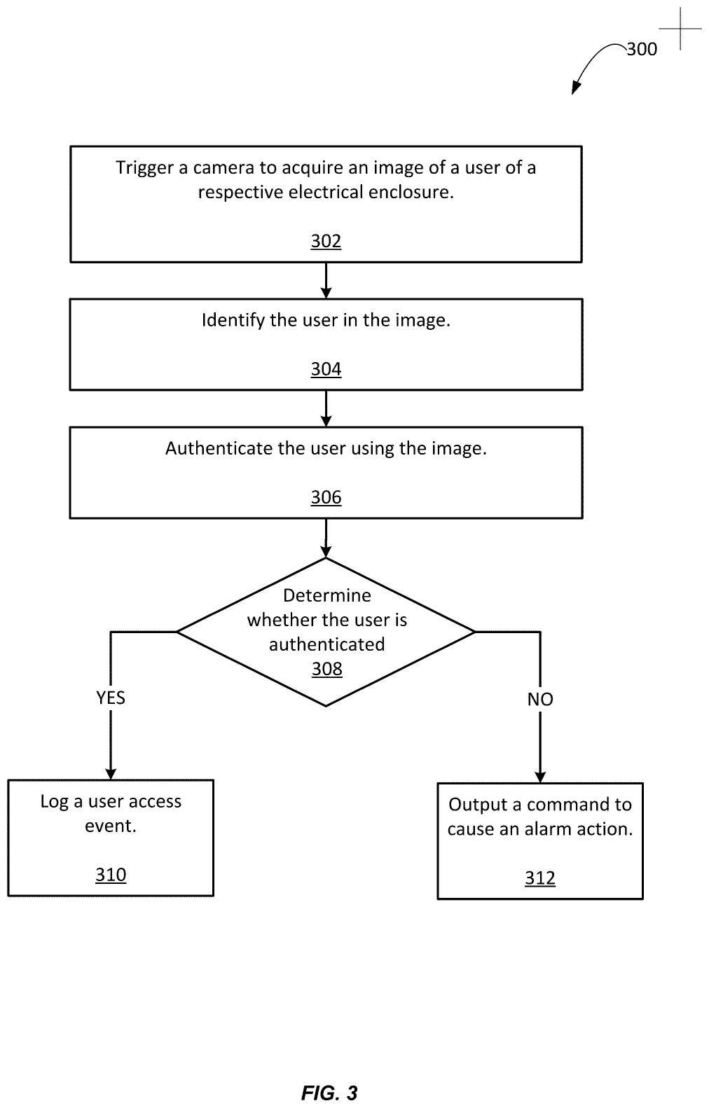

In some examples, the first electrical component of the one or more electrical components is a camera and the first action is triggering the camera to acquire an image of a user of the respective electrical enclosure. The image may be acquired for authentication, authorization, logging, or other purpose. An example of a process involving using a camera for authentication is described in FIG. 3 below.

FIG. 3 illustrates a flow chart representing process 300 demonstrating actions taken by a pool automation controller at an electrical enclosure, according to some aspects of the present disclosure. In some examples, the pool automation controller may perform these actions in response to detecting a door of an electrical enclosure is open, such as the electrical enclosure described further in the description of FIG. 1.

Process 300 may begin at block 302 which includes triggering a camera to acquire an image of a user of a respective electrical enclosure. For example, a pool automation controller, such as the pool automation controller described in FIG. 1, may trigger the camera. The camera may take a photo of a user interacting with the electrical enclosure, such as a photo of the user opening a door of the electrical enclosure. In some examples, the pool automation controller may trigger the camera in response to a signal from a switch or sensor indicating that a door of the electrical enclosure is open.

At block 304, process 300 may include identifying the user in the image. For example, the user in the image can be identified using facial recognition algorithms or biometric authentication software integrated into the pool automation controller. The facial recognition algorithms may be based on machine or computer vision techniques such as convolutional neural networks (“CNNs”) or deep learning models trained to detect and match facial features.

At block 306, process 300 may include authenticating the user using the image. In some examples, the pool automation controller may authenticate a user's identity from the photo taken at block 302. For example, the pool automation controller may compare the photo taken by the camera in block 302 to a database of user photos to authenticate a user's identity. In further examples, the pool automation controller may transmit the photo to an edge computing device or other device to perform authentication and may receive a message indicating whether the user's identity is authenticated. Authentication may include identifying a user's identity and determining whether the user has authority to access the electrical enclosure associated with the pool automation controller. Additionally or alternatively, the pool automation controller may send the photo to a user device.

At block 308, the process 300 may include determining whether the user is authenticated. For example, in block 306, the authentication operation may result in a Boolean output indicating the result of the authentication operation. In some examples, the output of the authentication may include additional information relating to the authentication such as user identity information and a set of authorizations associated with the user. The output of the authentication operation may be in a suitable data formation such as a JSON object include a field for the result of the authentication operation and additional fields for the identity, authorization, and other metadata generated or retrieved during the authentication operation.

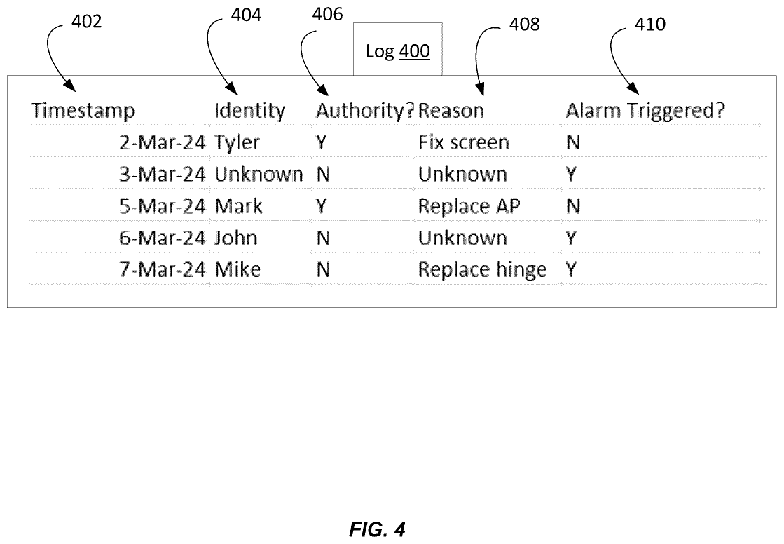

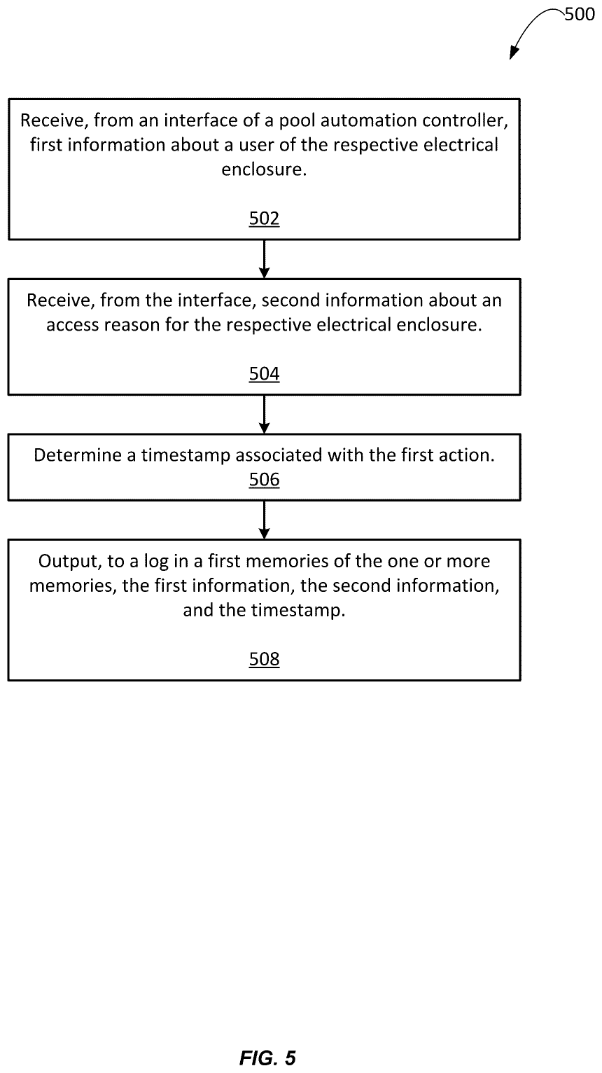

At block 310, process 300 may include logging a user access event following a successful authentication. The user access event may correspond to a user interaction with the pool automation controller and electrical enclosure. In some examples, logging the user interaction may be an automatic process performed by the pool automation controller. For example, the pool automation controller may determine the identity of the user interacting with the pool automation controller and electrical enclosure from block 304 of process 300 and may determine what changes the user made by detecting changes to the electrical enclosure and its electrical components. For example, the pool automation controller may determine that a new electrical component was added to the electrical enclosure by detecting a new device or a change in impedance values of an electrical component. In further examples, the pool automation controller may detect that an electrical component or peripheral was unplugged from the electrical enclosure or automation controller and determine that the electrical component or peripheral was removed. In further examples, users may interact with an interface of the pool automation controller to input actions taken by the user when interacting with the electrical enclosure and automation controller. An example of a log including some user access events is shown below in FIG. 4 and a process for generating user access events is described in FIG. 5.

At block 312, process 300 may include outputting a command to cause an alarm action following an unsuccessful authentication. For example, the electrical enclosure may include an audible alarm component controlled by the pool automation controller. The pool automation controller can output a comment to activate the audible alarm. The audible alarm may have connected speakers to alert nearby personnel. The alarm action may also include other activations such as illuminating warning lights on the electrical enclosure or generating notifications or alerts that can be received by user client devices such as smartphones. Additionally, the alarm action may include logging the failed authentication attempt, including the timestamp and image of the individual, to support additional security actions or subsequent investigations.

FIG. 4 illustrates an example log 400 of user interactions with the electrical enclosure and automation controller, according to some aspects of the present disclosure. Log 400 is an example depiction of the log described in the description of block 308 of FIG. 3 above. By way of non-limiting example, the log 400 includes various columns such as columns associated with timestamps 402, user identities 404, user authorities 406, reasons for user interactions 408, and whether an alarm was triggered 410 by the user interactions.

For example, the timestamps 402 may indicate the time and date that the user identified in the user identities 404 column interacted with the electrical enclosure and automation controller. The reasons for user interactions 408 column may include explanations for why the user interacted with the electrical enclosure and automation controller. The user authorities 406 (sometimes referred to as user authorizations) column may indicate whether the user has been granted the authority to interact with the electrical enclosure and automation controller. In further examples, user authorities 406 may indicate whether a user has the authority to perform actions associated with the reasons for user interactions 408 column. For example, a user may have the authority to open an electrical enclosure to fix a screen but may lack the authority to perform other actions, such as opening the electrical enclosure to fix an access point (AP). The column associated with whether an alarm was triggered 410 may indicate whether a user's interaction with the electrical enclosure and automation controller triggered an alarm.

Additional columns indicating further information associated with a user's interaction with the electrical enclosure and automation controller may be included in the log 400. For example, additional columns in the log 400 may include details such as the duration of the enclosure access, specific electrical components interacted with, or system changes made during the access event. Additional logs or tables could provide additional functionality such as tracking of maintenance tasks. For instance, the completion or status of electrical component replacements or diagnostics can be logged by the pool automation controller.

In some examples, the pool automation controller may be configured to analyze the log 400 (or other logs) to identify patterns of user interactions with the electrical enclosure. For example, examination of historical access data can be used to determine recurring maintenance schedules or pinpoint irregularities that may require attention. For instance, if the logs reveal that a specific user consistently accesses the enclosure at regular intervals to perform routine maintenance, the controller can predict future maintenance needs and generate reminders or alerts to ensure timely upkeep. Conversely, if the expected or minimal maintenance requirements are not maintained or if access to the enclosure becomes unusually frequent, the system may identify these anomalies as potential indicators of equipment issues or unauthorized activity. In some examples, the pool automation controller can be further configured to output notifications to designated users (e.g., maintenance personnel) and recommend specific actions to improve system performance. The notifications may include information such as details about the type of maintenance required, the urgency of the task, and a summary of previous interactions with the enclosure.

FIG. 5 illustrates a flow chart representing an example process 500 for logging user access events a pool automation controller at an electrical enclosure, according to some aspects of the present disclosure. In some examples, the pool automation controller may perform these actions in response to detecting a door of an electrical enclosure is open, such as the electrical enclosure 100 described further in the description of FIG. 1. The process 500 may correspond to the logging of the user access event described in block 308 of FIG. 3.

Process 500 may begin at block 502 which includes receiving, from an interface of a pool automation controller, first information about a user of the respective electrical enclosure. For example, the pool automation controller may be similar in some respects to the pool automation controller 110 described in FIG. 1. For example, following identification and authentication in blocks 304 and 306 of FIG. 3, the first information about the user may be obtained from a database local to the pool automation controller or a remote database (e.g., a cloud-hosted database instance). The first information may include a username, authentication status, authorizations or authorities, and so on.

At block 504, the process 500 may include receiving, from the interface, second information about an access reason for the respective electrical enclosure. For example, the interface can prompt the authenticated user to enter an access reason using a suitable input device such as a touchscreen. The access reason may include free-form text strings, text strings selected from a pre-populated user interface control, icons, or other representations of access reasons.

At block 506, the process 500 may include determining a timestamp associated with the first action. For example, the pool automation controller can access a local timekeeping device or remote network time protocol (e.g., NTP) to obtain the time and date corresponding to the user access event. The time and date may be converted to a suitable format for logging such as a POSIX-compliant epoch timestamp.

At block 508, the process 500 may include outputting, to a log in a memory (e.g., a filesystem or volatile memory of the pool automation controller 110), the first information, the second information, and the timestamp. For example, the first information, the second information, and the timestamp may be output to a log such as the log 400 shown above in FIG. 4. In some examples, the first information, the second information, and the timestamp may be inserted into a database table, such as a relational database, using a suitable SQL command.

FIG. 6 illustrates a flow chart representing process 600 showing adjustments to electrical components responsive to changing the position of the door of a housing or electrical enclosure, according to some aspects of the present disclosure. The operations described in this method may be performed may components of the housing or electrical enclosure, including one or more electrical components.

Process 600 may begin at block 602. At block 602, responsive to receiving a first signal from a switch configured to detect a position of a door of the electrical enclosure, where the first signal corresponds to the door opening, a component causes a first change in state of a first electrical component. For example, the electrical component may be a light affixed the electrical enclosure, a camera, alarm, or other electrical component. Changing the position of the switch can have the effect of opening or closing a circuit, causing current to flow. The resultant current can actuate a relay that causes the state change in the electrical component or it can cause the state change directly. For example, when the switch is also the component, opening the door may cause a circuit to close which causes a light to illuminate or an alarm to sound. Or, if a relay is the component, the switch can cause actuation of the relay, which can in turn, causes a light to illuminate or an alarm to sound.

At block 604, the component, responsive to receiving a second signal from the switch, where the second signal corresponds to the door closing, causes a second change in state of the first electrical component. Similarly to block 602, the second signal can cause a circuit to open or close, which can actuate a relay (or other remote operation device) or cause the second state change directly. Continuing the examples above, the second state change may be extinguishing the light or silencing the alarm.

In some examples, the first electrical component is the switch. For example, the switch may be a limit switch that changes state based on the position of the door and provides a binary signal indicative of the door's position (e.g., open or closed). In this example, the action may be an update to a door status stored in a memory (e.g., local volatile memory) to a status corresponding to the position of the door. For example, a processor (e.g., a processor of a pool automation controller) may receive the binary signal from the limit switch and update a register or memory location to reflect that the door is in an open or closed state.

In some examples, the pool automation controller can output information about the door position to a remote server configured to generate notifications based on the position of the door. For instance, the remote server may be executing a web application configured to receive the information about the door position and send push notifications, emails, alerts, etc. to registered users when the door of the electrical enclosure has been open for longer than a predetermined threshold period of time (e.g., 15 minutes, 2 hours, 1 day, etc.).

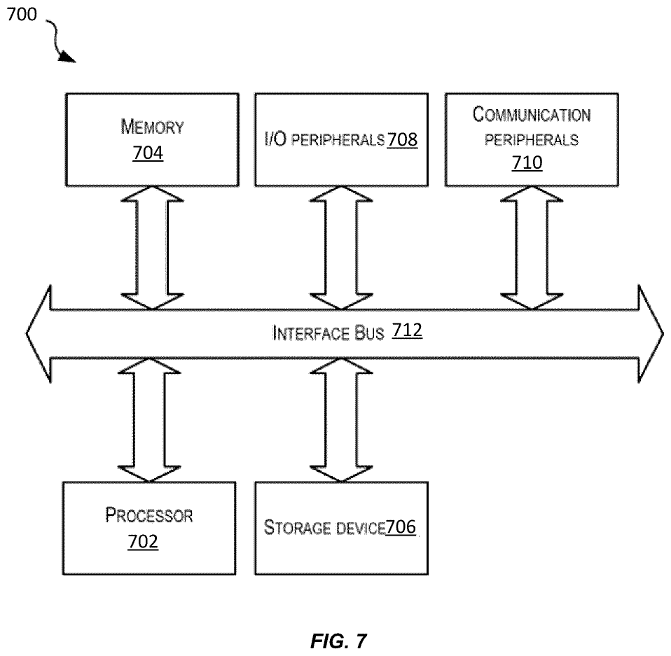

FIG. 7 illustrates examples of components of a computer system 700, according to some aspects of the present disclosure. The computer system 700 is an example of controllers and/or microcontrollers of pool equipment and/or pool automation systems including automation controllers such as the pool automation controller further described in the description of FIG. 1, and the like. The computer system 700 may be housed in the electrical enclosure described in the description of FIG. 1.

The computer system 700 may include at least a processor 702, a memory 704, a storage device 706, input/output peripherals (I/O) 708, communication peripherals 710, and an interface bus 712. The interface bus 712 is configured to communicate, transmit, and transfer data, controls, and commands among the various components of the computer system 700. The memory 704 and the storage device 706 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 704 and the storage device 706 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 700.

Further, the memory 704 may include an operating system, programs, and applications. The processor 702 is configured to execute the stored instructions and includes, for example, a logical processing unit, a microprocessor, a digital signal processor, and other processors. The memory 704 and/or the processor 702 can be virtualized and can be hosted within another computing system of, for example, a cloud network or a data center. The I/O peripherals 708 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 708 are connected to the processor 702 through any of the ports coupled to the interface bus 712. The communication peripherals 710 are configured to facilitate communication between the computer system 700 and other computing devices over a communications network and include, for example, a network interface controller, modem, wireless and wired interface cards, antenna, and other communication peripherals.

### General Considerations

The examples described herein are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the disclosure. Further, although applicant has described devices and techniques for use principally with automated controllers, persons skilled in the relevant field will recognize that the present invention conceivably could be employed in connection with other objects and in other manners. Finally, references to “pools” and “swimming pools” herein may also refer to spas or other water containing vessels used for recreation, training, or therapy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Although applicant has described devices and techniques for use principally with swimming pools and spas, persons skilled in the relevant field will recognize that the present invention may be employed in connection with other objects and in other manners. Finally, references to “pools” and “swimming pools” herein may also refer to spas or other water containing vessels used for recreation or therapy and for which cleaning is needed or desired.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

### EXAMPLES

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

As used below, any reference to a series of examples is to be understood as a reference to each of those examples disjunctively (e.g., “Examples 1-4” is to be understood as “Examples 1, 2, 3, or 4”).

Example 1 is an electrical enclosure for a pool or spa system, comprising: a door; a switch configured to detect a position of the door; and one or more electrical components associated with operation of the pool or spa system including a first electrical component, wherein the first electrical component performs an action in response to a change in the position of the door.

Example 2 is the electrical enclosure of example(s) 1, further comprising: a pool automation controller configured to perform one or more actions responsive to a signal from the switch, wherein the pool automation controller comprises: one or more memories; one or more non-transitory computer-readable media; and one or more processors communicatively coupled to the one or more non-transitory computer-readable media, the one or more processors configured to execute processor-executable instructions stored in the non-transitory computer-readable media to perform operations including: outputting a first command to cause a first action by the first electrical component responsive to receiving a first signal from the switch, the first signal corresponding to the door opening; and outputting a second command to cause a second action by the first electrical component responsive to receiving a second signal from the switch, the first signal corresponding to the door closing.

Example 3 is the electrical enclosure of any of example(s) 1-2, wherein: the first electrical component of the one or more electrical components is an relay; and the first action is applying electrical power using the relay to a first piece of pool or spa equipment of one or more pieces of pool or spa equipment; and the second action is removing the electrical power using the relay from the first piece of pool or spa equipment.

Example 4 is the electrical enclosure of any of example(s) 1-3, wherein: the first electrical component of the one or more electrical components is a camera; and the first action is triggering the camera to acquire an image of a user of the respective electrical enclosure.

Example 5 is the electrical enclosure of example(s) 4, wherein the processor-executable instructions further include additional operations including: identifying the user in the image; authenticating the user using the image; responsive to a successful authentication, logging a user access event; and responsive to an unsuccessful authentication, outputting a third command to cause an alarm action.

Example 6 is the electrical enclosure of any of example(s) 1-5, wherein the processor-executable instructions further include additional operations including: receiving, from an interface of the pool automation controller, first information about a user of the respective electrical enclosure; receiving, from the interface, second information about an access reason for the respective electrical enclosure; determining a timestamp associated with the first action; and outputting, to a log in a first memories of the one or more memories, the first information, the second information, and the timestamp.

Example 7 is the electrical enclosure of any of example(s) 1-6, wherein the pool automation controller is further configured to perform predictive maintenance operations, comprising: analyzing access logs stored in a memory of the one or more memories to identify patterns of user access; determining a maintenance schedule based on historical access data; and outputting a notification including a recommended maintenance action based on the maintenance schedule.

Example 8 is the electrical enclosure of any of example(s) 1-7, wherein: the first electrical component is a light mounted on the electrical enclosure; the first action is a first change in state of the light to a first state; and the second action is a second change in state of the light to a second state.

Example 9 is the electrical enclosure of any of example(s) 1-8, wherein the pool automation controller is further configured to: activate a low-power mode for the first electrical component when the door of the respective electrical enclosure is closed; and activate a high-power mode for the first electrical component when the door is opened.

Example 10 is the electrical enclosure of any of example(s) 1-9, wherein the pool automation controller is further configured to: detect an addition of a new component to the electrical enclosure by identifying a new device or a change in impedance values of an existing component; and detect a removal of a component from the electrical enclosure by determining a loss of connection.

Example 11 is the electrical enclosure of any of example(s) 1-10, wherein the first electrical component is the switch; and the action is an update to a door status stored in a memory of one or more memories to a status corresponding to the position of the door.

Example 12 is a pool or spa system, comprising: a housing that defines an interior volume; a door mounted to the housing and configured to selectively enclose the interior volume; a first electrical component disposed within the housing, the first electrical component associated with operation of the pool or spa system and configured to perform one or more actions based on a position of the door; a switch disposed within the housing configured to detect the position of the door; and one or more pieces of pool or spa equipment.

Example 13 is the pool or spa system of example(s) 12, further comprising a pool automation controller comprising: one or more memories; one or more non-transitory computer-readable media; and one or more processors communicatively coupled to the one or more non-transitory computer-readable media, the one or more processors configured to execute processor-executable instructions stored in the non-transitory computer-readable media to perform operations including: outputting a first command to cause a first action by the first electrical component responsive to receiving a first signal from the switch, the first signal corresponding to the door opening; and outputting a second command to cause a second action by the first electrical component responsive to receiving a second signal from the switch, the first signal corresponding to the door closing.

Example 14 is the pool or spa system of any of example(s) 12-13, wherein: the first electrical component is a relay; the first action is applying electrical power to a first piece of pool or spa equipment of one or more pieces of pool or spa equipment; and the second action is removing the electrical power from a first piece of pool or spa equipment of the one or more pieces of pool or spa equipment.

Example 15 is the pool or spa system of any of example(s) 12-14, further comprising: the first electrical component is a light mounted on the housing; the first action is a first change in color of the light to a first color; and the second action is a second change in color of the light to a second color.

Example 16 is a method for operating electrical components of a pool or spa system by a pool automation controller, comprising: outputting a first command to cause a first action by an electrical component of an electrical enclosure responsive to receiving a first signal from a switch configured to detect a position of a door of the electrical enclosure, the first signal corresponding to the door opening; and outputting a second command to cause a second action by the electrical component responsive to receiving a second signal from the switch, the second signal corresponding to the door closing.

Example 17 is the method of example(s) 16, wherein: the electrical component is a light mounted on the electrical enclosure; the first action is a first change in state of the light to a first state; and the second action is a second change in state of the light to a second state.

Example 18 is the method of any of example(s) 16-17, wherein: the electrical component comprises a camera; the first action is triggering the camera to acquire an image; and the method further comprising: identifying a user in the image; and authenticating the user in the image.

Example 19 is the method of any of example(s) 16-18, the method further comprising: in accordance with a determination based on the image that the user is authenticated, logging a user access event.

Example 20 is the method of any of example(s) 16-19, wherein: the first action is logging a user access event; and the method further comprises: receiving, from an interface of the pool automation controller, first information corresponding to a user of the electrical enclosure; receiving, from the interface, second information corresponding to an access reason for the electrical enclosure; determining a timestamp associated with the first action; and outputting, to a log in a memory, the first information, the second information, and the timestamp.

What is claimed is:

1. An electrical enclosure for a pool or spa system, comprising:
a door;
a switch configured to detect a position of the door; and
one or more electrical components associated with operation of the pool or spa system including a first electrical component, wherein the first electrical component performs an action in response to a change in the position of the door.

2. The electrical enclosure of claim 1, further comprising:
a pool automation controller configured to perform one or more actions responsive to a signal from the switch, wherein the pool automation controller comprises:
one or more memories;
one or more non-transitory computer-readable media; and
one or more processors communicatively coupled to the one or more non-transitory computer-readable media, the one or more processors configured to execute processor-executable instructions stored in the non-transitory computer-readable media to perform operations including:
outputting a first command to cause a first action by the first electrical component responsive to receiving a first signal from the switch, the first signal corresponding to the door opening; and
outputting a second command to cause a second action by the first electrical component responsive to receiving a second signal from the switch, the first signal corresponding to the door closing.

3. The electrical enclosure of claim 2, wherein:
the first electrical component of the one or more electrical components is an relay; and
the first action is applying electrical power using the relay to a first piece of pool or spa equipment of one or more pieces of pool or spa equipment; and
the second action is removing the electrical power using the relay from the first piece of pool or spa equipment.

4. The electrical enclosure of claim 2, wherein:
the first electrical component of the one or more electrical components is a camera; and
the first action is triggering the camera to acquire an image of a user of the respective electrical enclosure.

5. The electrical enclosure of claim 4, wherein the processor-executable instructions further include additional operations including:
identifying the user in the image;
authenticating the user using the image;
responsive to a successful authentication, logging a user access event; and
responsive to an unsuccessful authentication, outputting a third command to cause an alarm action.

6. The electrical enclosure of claim 2, wherein the processor-executable instructions further include additional operations including:
receiving, from an interface of the pool automation controller, first information about a user of the respective electrical enclosure;
receiving, from the interface, second information about an access reason for the respective electrical enclosure;
determining a timestamp associated with the first action; and
outputting, to a log in a first memories of the one or more memories, the first information, the second information, and the timestamp.

7. The electrical enclosure of claim 2, wherein the pool automation controller is further configured to perform predictive maintenance operations, comprising:
analyzing access logs stored in a memory of the one or more memories to identify patterns of user access;
determining a maintenance schedule based on historical access data; and
outputting a notification including a recommended maintenance action based on the maintenance schedule.

8. The electrical enclosure of claim 2, wherein:
the first electrical component is a light mounted on the electrical enclosure;
the first action is a first change in state of the light to a first state; and
the second action is a second change in state of the light to a second state.

9. The electrical enclosure of claim 2, wherein the pool automation controller is further configured to:
activate a low-power mode for the first electrical component when the door of the respective electrical enclosure is closed; and
activate a high-power mode for the first electrical component when the door is opened.

10. The electrical enclosure of claim 2, wherein the pool automation controller is further configured to:
detect an addition of a new component to the electrical enclosure by identifying a new device or a change in impedance values of an existing component; and
detect a removal of a component from the electrical enclosure by determining a loss of connection.

11. The electrical enclosure of claim 1, wherein
the first electrical component is the switch; and
the action is an update to a door status stored in a memory of one or more memories to a status corresponding to the position of the door.

12. A pool or spa system, comprising:
a housing that defines an interior volume;
a door mounted to the housing and configured to selectively enclose the interior volume;
a first electrical component disposed within the housing, the first electrical component associated with operation of the pool or spa system and configured to perform one or more actions based on a position of the door;
a switch disposed within the housing configured to detect the position of the door; and
one or more pieces of pool or spa equipment.

13. The pool or spa system of claim 12, further comprising a pool automation controller comprising:
one or more memories;
one or more non-transitory computer-readable media; and
one or more processors communicatively coupled to the one or more non-transitory computer-readable media, the one or more processors configured to execute processor-executable instructions stored in the non-transitory computer-readable media to perform operations including:
outputting a first command to cause a first action by the first electrical component responsive to receiving a first signal from the switch, the first signal corresponding to the door opening; and
outputting a second command to cause a second action by the first electrical component responsive to receiving a second signal from the switch, the first signal corresponding to the door closing.

14. The pool or spa system of claim 13, wherein:
the first electrical component is a relay;
the first action is applying electrical power to a first piece of pool or spa equipment of one or more pieces of pool or spa equipment; and
the second action is removing the electrical power from a first piece of pool or spa equipment of the one or more pieces of pool or spa equipment.

15. The pool or spa system of claim 13, further comprising:
the first electrical component is a light mounted on the housing;
the first action is a first change in color of the light to a first color; and
the second action is a second change in color of the light to a second color.

16. A method for operating electrical components of a pool or spa system by a pool automation controller, comprising:
outputting a first command to cause a first action by an electrical component of an electrical enclosure responsive to receiving a first signal from a switch configured to detect a position of a door of the electrical enclosure, the first signal corresponding to the door opening; and
outputting a second command to cause a second action by the electrical component responsive to receiving a second signal from the switch, the second signal corresponding to the door closing.

17. The method of claim 16, wherein:
the electrical component is a light mounted on the electrical enclosure;
the first action is a first change in state of the light to a first state; and
the second action is a second change in state of the light to a second state.

18. The method of claim 16, wherein:
the electrical component comprises a camera;
the first action is triggering the camera to acquire an image; and the method further comprising:
identifying a user in the image; and
authenticating the user in the image.

19. The method of claim 18, the method further comprising:
in accordance with a determination based on the image that the user is authenticated, logging a user access event.

20. The method of claim 16, wherein:
the first action is logging a user access event; and the method further comprises:
receiving, from an interface of the pool automation controller, first information corresponding to a user of the electrical enclosure;
receiving, from the interface, second information corresponding to an access reason for the electrical enclosure;
determining a timestamp associated with the first action; and
outputting, to a log in a memory, the first information, the second information, and the timestamp.
